(19) United States
(12) Patent Application Publication
(10) Pub. No.: US 2025/0103061 A1
(43) Pub. Date: Mar. 27, 2025

(54) UNMANNED AERIAL VEHICLE PROVIDED WITH DETACHABLE TRANSPORT MISSION APPARATUS

(71) Applicant: VORASKY CORP., Seoul (KR)

(72) Inventor: Dong Hwan LEE, Hwaseong-si Gyeonggi-do (KR)

(73) Assignee: VORASKY CORP., Seoul (KR)

(21) Appl. No.: 18/729,884

(22) PCT Filed: Aug. 3, 2022
(86) PCT No.: PCT/KR2022/011458

§ 371 Date: Jul. 17, 2024

(30) Foreign Application Priority Data
Jan. 19, 2022 (KR) 10-2022-0007991

(51) Int. Cl. G05D 1/667; G05D 105/28; G05D 105/35; G05D 109/25

(52) U.S. Cl. CPC G05D 1/667; G05D 2105/28; G05D 2105/35; G05D 2109/254

(57) ABSTRACT

The present invention relates to an unmanned aerial vehicle provided with a detachable transport mission apparatus, which allows various types of cargo to be detachably attached and transported. To this end, the present invention provides an unmanned aerial vehicle provided with a detachable transport mission apparatus, the unmanned aerial vehicle comprising: a main body, a transport mission apparatus detachably coupled to the main body to transport certain items, a first exchange unit provided to a lower side of the main body to be coupled to or uncoupled from the transport mission apparatus, and a second exchange unit provided to an upper side of the transport mission apparatus to be coupled to or uncoupled from the first exchange unit.

### TECHNICAL FIELD

The present invention relates to an unmanned aerial vehicle provided with a detachable transport mission apparatus, and more particularly to an unmanned aerial vehicle provided with a detachable transport mission apparatus and capable of transporting various types of cargo in a detachably coupled manner.

### BACKGROUND ART

An unmanned aerial vehicle (drone) refers to an unmanned aircraft that can be flown and controlled by guidance or automatic control of radio waves without a pilot aboard.

Although such unmanned aerial vehicles have been developed and used for military purposes to reconnoiter and destroy enemy sites in international conflict zones, in recent years, the use of unmanned aerial vehicles has been gradually expanding due to convenience of transportation and storage and ease of operation.

For example, since the unmanned aerial vehicles are relatively lightweight and easy to maneuver, the unmanned aerial vehicles are frequently used for broadcast filming and are also used to observe wildlife and monitor poaching over a wide range of areas and for dangerous missions to fly into disaster and catastrophe areas to scout situations therein.

Currently, research on unmanned aerial vehicles has been actively conducted together with various attempts to expand the scope of unmanned aerial vehicles adopting various tools suitable for user utilization, and the development of various types of unmanned aerial vehicles equipped with various types of fixtures and devices to securely carry items is also emerging.

However, the kind of item capable of being coupled to and transported on unmanned aerial vehicles is limited depending on the type of unmanned aerial vehicle, thereby making it difficult for one unmanned aerial vehicle to transport various types of cargo.

### DISCLOSURE

### Technical Problem

It is an object of present invention to provide an unmanned aerial vehicle provided with a detachable transport mission apparatus, which can expand diversity and utilization of the unmanned aerial vehicle and can provide a transport mission apparatus capable of being replaced according to a method and purpose.

It will be understood that the present invention is not limited to the above object and the above and other objects of the present invention will become apparent to those skilled in the art from the detailed description in conjunction with the accompanying drawings.

### Technical Solution

In accordance with one aspect of the present invention, an unmanned aerial vehicle provided with a detachable transport mission apparatus includes: a main body, a transport mission apparatus detachably coupled to the main body to transport certain items, a first exchange unit provided to a lower side of the main body to be coupled to or uncoupled from the transport mission apparatus, and a second exchange unit provided to an upper side of the transport mission apparatus to be coupled to or uncoupled from the first exchange unit.

The first exchange unit may include a first fitting holder protruding from a lower surface of the main body and a first securing coupler disposed on the lower surface of the main body and including at least one first securing hole.

The second exchange unit may include a second fitting holder disposed on an upper surface of the transport mission apparatus and defining a fitting hole therein, and a second securing coupler disposed on the upper surface of the transport mission apparatus and including at least one second securing hole.

The first fitting holder may be inserted into the fitting hole formed in the second fitting holder, and the first securing hole and the second securing hole may be disposed to face each other such that a center of the first securing hole and a center of the second securing hole are collinearly located.

### Advantageous Effects

According to the present invention, the unmanned aerial vehicle provided with the detachable transport mission apparatus has one or more of the following effects.

First, one unmanned aerial vehicle can be interchangeably equipped with various transport mission apparatuses, such as general cargo, artillery shells, and the like, thereby eliminating the need for multifunctional unmanned aerial vehicles.

Second, the first exchange unit and the second exchange unit are coupled to each other through fitting, thereby making it easier to couple and uncouple the transport mission unit to and from the unmanned aerial vehicle.

It should be understood that the present invention is not limited thereto and the above and other effects of the present invention will become apparent from the detailed description of the following embodiments.

### DESCRIPTION OF DRAWINGS

FIG. 1 is a schematic diagram of an unmanned aerial vehicle provided with a detachable transport mission apparatus according to a first embodiment of the present invention.

FIG. 2 is a view of a main body and a first exchange unit of the unmanned aerial vehicle according to the first embodiment of the present invention.

FIG. 3 is a view of a transport mission apparatus and a second exchange unit of the unmanned aerial vehicle according to the first embodiment of the present invention.

FIG. 4 is a schematic diagram of an unmanned aerial vehicle provided with a detachable transport mission apparatus according to a second embodiment of the present invention.

FIG. 5 is a view of a transport mission apparatus and a second exchange unit of the unmanned aerial vehicle according to the second embodiment of the present invention.

FIG. 6 is a schematic diagram of an unmanned aerial vehicle provided with a detachable transport mission apparatus according to a third embodiment of the present invention.

FIG. 7 is a view of a transport mission apparatus and a second exchange unit of the unmanned aerial vehicle according to the third embodiment of the present invention.

FIG. 8 is a schematic diagram of an unmanned aerial vehicle provided with a detachable transport mission apparatus according to a fourth embodiment of the present invention.

FIG. 9 is a view of a transport mission apparatus and a second exchange unit of the unmanned aerial vehicle according to the fourth embodiment of the present invention.

### BEST MODE

Hereinafter, various aspects, features, and advantages of the present invention will be described with reference to the accompanying drawings. However, it should be understood that the present invention is not limited to the following embodiments and may be embodied in different ways. In addition, it should be understood that the following embodiments are provided for complete disclosure and thorough understanding of the present invention by those skilled in the art, and that the present invention is defined only by the scope of claims. Like components will be denoted by like reference numerals throughout the specification.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

When an element is referred to as being “connected to,” or “coupled to” another element, it may be directly connected or coupled to the other element or intervening elements may be present. However, when an element is referred to as being “directly connected to,” or “directly coupled to” another element, there are no intervening elements present. Other expressions for description of the relationship between components should also be interpreted in the same manner.

Unless otherwise defined herein, all terms including technical or scientific terms used herein have the same meanings as commonly understood by those skilled in the art to which the present invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein

Herein, spatially relative terms, such as “upper end,” “lower end,” “upper surface,” “lower surface,” “upper portion,” “lower portion,” and the like, may be used to distinguish the relative positions of components.

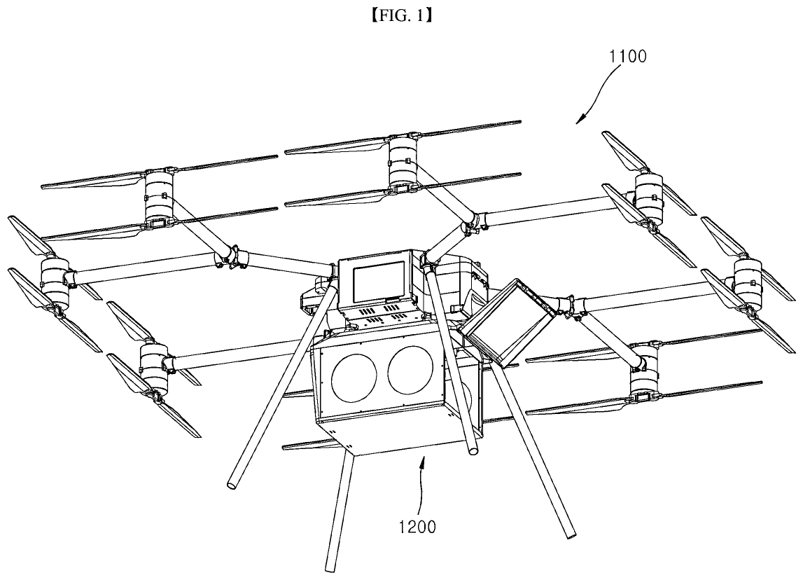

FIG. 1 is a schematic diagram of an unmanned aerial vehicle provided with a detachable transport mission apparatus according to a first embodiment of the present invention.

Referring to FIG. 1, the unmanned aerial vehicle according to the first embodiment includes a main body 1100, a transport mission apparatus, a first exchange unit 1300, and a second exchange unit 1400.

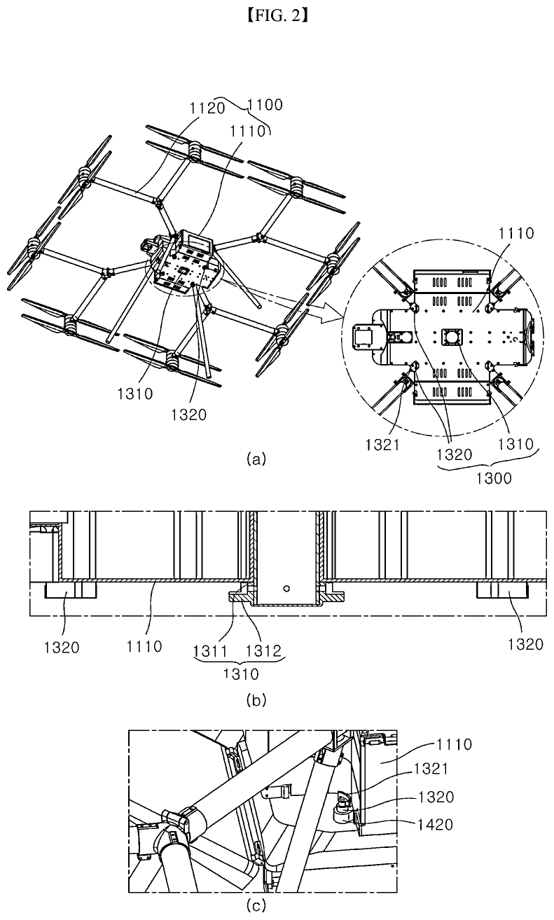

The main body 1100 corresponds to a drone and includes an aircraft body 1110 and a propeller 1120, which will be described below in more detail with reference to FIG. 2.

The aircraft body 1110 is provided with a communication unit, a first controller, a propeller driver, a weight sensor, and the like therein, in which the propeller 1120 is coupled to an upper side of the aircraft body 1110 and is operated by the propeller driver to levitate the aircraft body 1110 from the ground and move the aircraft body 1110 to a destination.

Here, the weight sensor measures the weight of the transport mission apparatus to detect whether the transport mission apparatus engages with or disengages from the main body 1100 through coupling between the first exchange unit 1300 and the second exchange unit 1400, and sends a detection result to the first controller.

When the first controller receives information as to whether the transport mission apparatus engages with or disengages from the main body 1100, the propeller driver operates the propeller 1120 to transport the transport mission apparatus to a destination or to a destination where another transport mission apparatus is located.

The transport mission apparatus is detachably coupled to the main body 1100 to transport a certain item, and will be described below.

The first exchange unit 1300 is provided to the main body, specifically to a lower side of the aircraft body 1110, and couples and uncouples the transport mission apparatus with respect to the main body. Details of the first exchange unit 1300 will be described below with reference to FIG. 2.

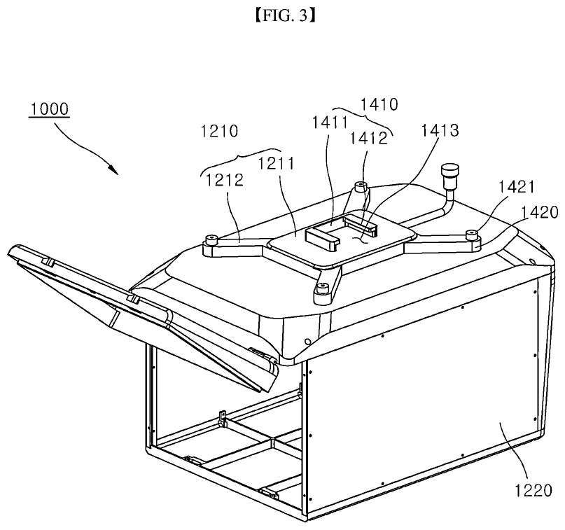

The second exchange unit 1400 is provided to an upper side of the transport mission apparatus to be coupled to or uncoupled from the first exchange unit 1300 such that the unmanned aerial vehicle can be detachably coupled to the transport mission apparatus. Details of the second exchange unit 1400 will be described below with reference to FIG. 3.

FIG. 2 is a view of the main body 1100 and the first exchange unit 1300 of the unmanned aerial vehicle according to the first embodiment of the present invention.

The main body 1100 includes the aircraft body 1110 and the propeller 1120.

The aircraft body 1110 is provided with the communication unit, the controller, the propeller driver, the weight sensor, and the like therein, in which the propeller 1120 is coupled to the upper surface of the aircraft body 1110 and is operated by the propeller driver to levitate the aircraft body 1110 from the ground and move the aircraft body 1110 to a destination.

The first exchange unit 1300 includes a first fitting holder 1310 and a first securing coupler 1320

The first fitting holder 1310 protrudes from a center of a lower surface of the main body 1100 and includes a first fitting body 1311 and a first fitting coupler 1312.

The first fitting body 1311 protrudes from the center of the lower surface of the main body 1100 and the first fitting coupler 1312 protrudes from a distal end of the first fitting body 1311, in which the first fitting coupler 1312 preferably has a smaller cross-sectional size than the first fitting body 1311.

The first securing coupler 1320 is disposed on the lower surface of the main body 1100 to protrude from the lower surface of the main body 1100, is provided in plural, and includes at least one first securing hole 1321. A plurality of first securing couplers 1320 is radially arranged about the first fitting body 1311.

FIG. 3 is a view of the transport mission apparatus and the second exchange unit 1400 of the unmanned aerial vehicle according to the first embodiment of the present invention.

The transport mission apparatus is a stationary cage transfer module 1200. The stationary cage transfer module 1200 includes a stationary cage support 1210 and a cage 1220.

The stationary cage support 1210 is formed on an upper surface thereof with a second fitting holder 1410 and a second securing coupler 1420. Specifically, the stationary cage support 1210 includes an exchange unit body 1211 and an exchange unit bar 1212.

The exchange unit body 1211 is coupled to an upper surface of the cage 1220 and the exchange unit bar 1212 is provided in plural and coupled to the upper surface of the cage 1220 to extend from the exchange unit body 1211 in a radial direction.

It should be understood that the shape of the stationary cage support 1210 may be varied depending on the shape and weight of the cage 1220 in various embodiments of the present invention.

The second exchange unit 1400 includes the second fitting holder 1410 and the second securing coupler 1420.

The second fitting holder 1410 is disposed on an upper surface of the exchange unit body 1211 and defines a fitting hole 1413 therein. Specifically, the second fitting holder 1410 includes a second fitting body 1411 and a second fitting coupler 1412.

The second fitting body 1411 protrudes from the center of the upper surface of the exchange unit body 1211 and is formed in an angled C-shape. An inner surface of the second fitting body 1411 has the same area and the same cross-sectional shape as the first fitting coupler 1312. Alternatively, the inner surface of the second fitting body 1411 has the same cross-sectional shape as the first fitting coupler 1312 and a larger area than the first fitting coupler 1312 by a predetermined size or more.

The second fitting coupler 1412 protrudes from an end of the second fitting body 1411 and preferably has a larger cross-sectional area than the second fitting body 1411.

Here, an inner surface of the second fitting coupler 1412 has the same area and the same cross-sectional shape as the first fitting body 1311. Alternatively, the inner surface of the second fitting coupler 1412 has the same cross-sectional shape as the first fitting body 1311 and a larger area than the first fitting body 1311 by a predetermined size or more.

In addition, the inner surface of the second fitting coupler 1412 has a larger area than the first fitting coupler 1312 and the fitting hole 1413 is defined in a region between the inner surfaces of the second fitting body 1411 such that the first fitting coupler 1312 is inserted into the fitting hole 1413 to allow the first fitting holder 1310 to be coupled to the second fitting holder 1410.

The second securing coupler 1420 is disposed on the exchange unit bar 1212 to protrude from an upper surface of the exchange unit bar 1212, is provided in plural, and includes at least one second securing hole 1421.

The second securing couplers 1420 are radially arranged about the second fitting body. Here, when the first fitting holder 1310 is inserted into the fitting hole 1413 defined in the second fitting holder 1410, the first securing hole 1321 and the second securing hole 1421 are preferably disposed at corresponding locations so as to face each other. In addition, a center of the first securing hole 1321 is collinear with a center of the second securing hole 1421 to allow a separate coupling member to simultaneously pass through the first securing hole 1321 and the second securing hole 1421 such that the first securing coupler 1320 and the second securing coupler 1420 are coupled to each other by the separate coupling member, thereby ensuring more reliable coupling between the first exchange unit 1300 and the second exchange unit 1400.

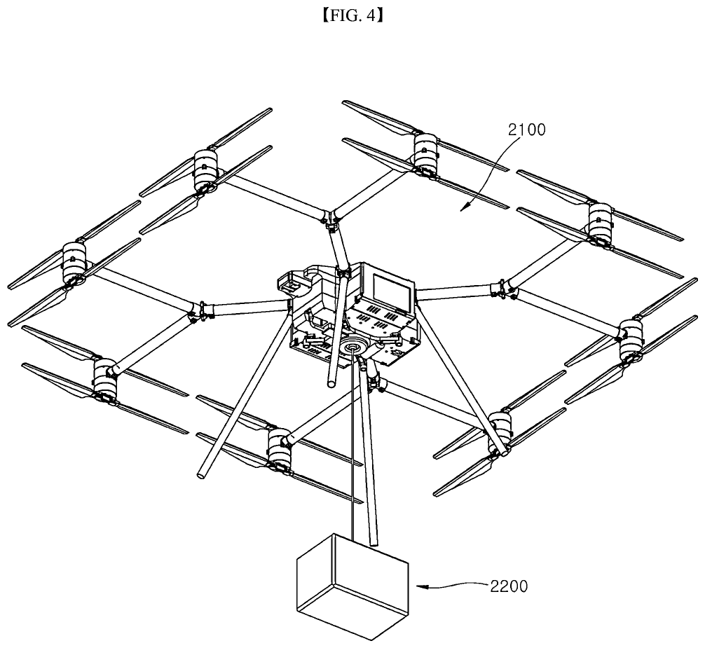

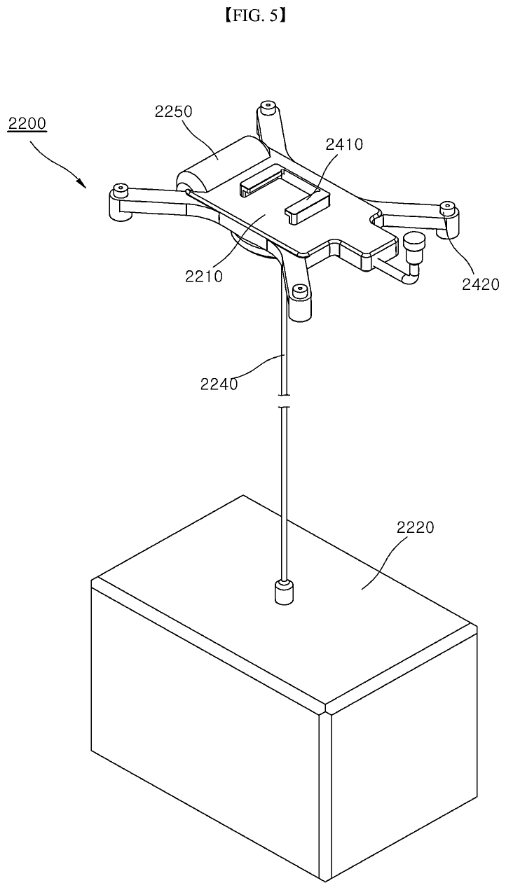

FIG. 4 is a schematic diagram of an unmanned aerial vehicle provided with a detachable transport mission apparatus according to a second embodiment of the present invention and FIG. 5 is a view of a transport mission apparatus and a second exchange unit 2400 of the unmanned aerial vehicle according to the second embodiment of the present invention.

Referring to FIG. 4 and FIG. 5, the unmanned aerial vehicle according to the second embodiment includes a main body 2100, a transport mission apparatus, a first exchange unit 2300, and a second exchange unit 2400. Here, details and description of each component of the unmanned aerial vehicle according to the second embodiment are the same as those of the unmanned aerial vehicle according to the first embodiment described above excluding some components.

According to the second embodiment, the transport mission apparatus of the unmanned aerial vehicle is a winch type cage transfer module 2200, which includes a winch type cage support 2210, a wire 2240, a winch unit 2250, a second controller, a first actuator, and a cage 2220.

The winch type cage support 2210 is formed on an upper surface thereof with a second fitting holder 2410 and a second securing coupler 2420.

One end of the wire 2240 is disposed inside the winch unit 2250 through the winch type cage support 2210 and the other end of the wire 2240 is disposed outside the winch type cage support 2210. Here, the other end of the wire 2240 is fixedly coupled to an upper surface of the cage 2220.

The winch unit 2250 is disposed on a side surface of the winch type cage support 2210 and is coupled to one end of the wire 2240 to move the cage 2220 up or down by winding or unwinding the wire 2240 according to a rotational direction thereof.

The second controller operates the first actuator in response to commands from the first controller and the first actuator operates the winch unit 2250 to move the cage 2220 up or down.

Detailed description of the same components of the unmanned aerial vehicle according to the second embodiment as those of the unmanned aerial vehicle according to the first embodiment described above are omitted.

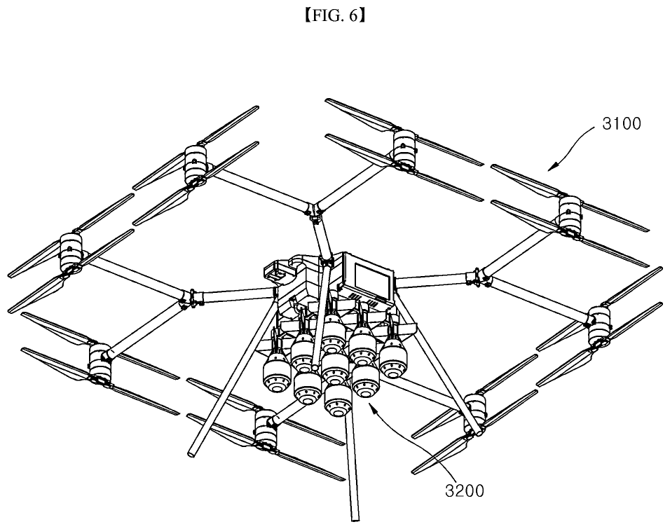

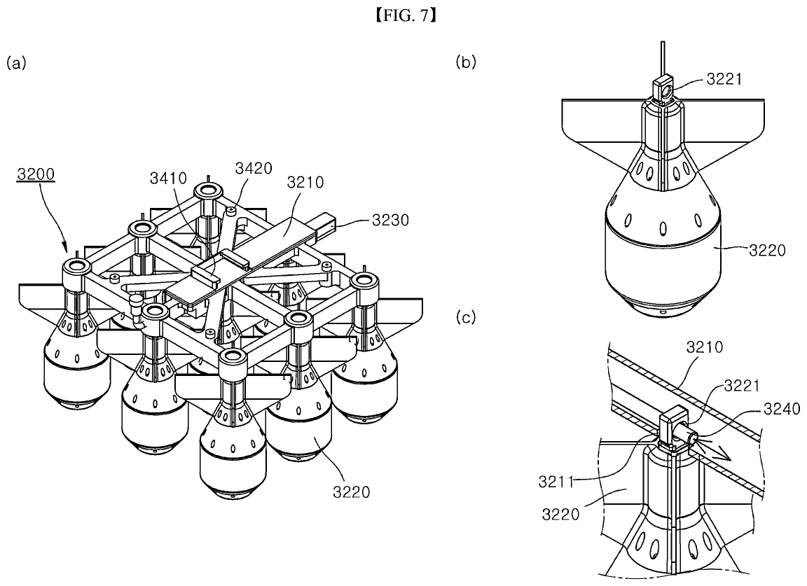

FIG. 6 is a schematic diagram of an unmanned aerial vehicle provided with a detachable transport mission apparatus according to a third embodiment of the present invention and FIG. 7 is a view of a transport mission apparatus and a second exchange unit 3400 of the unmanned aerial vehicle according to the third embodiment of the present invention.

Referring to FIG. 6 and FIG. 7, the unmanned aerial vehicle according to the third embodiment includes a main body 3100, a transport mission apparatus, a first exchange unit 3300, and a second exchange unit 3400. Here, details and description of each component of the unmanned aerial vehicle according to the third embodiment are the same as those of the unmanned aerial vehicle according to the first embodiment described above excluding some components.

According to the third embodiment, the transport mission apparatus of the unmanned aerial vehicle is a shell transfer module 3200, which includes a shell support 3210, a shell holding bar 3240, a second controller, a second actuator 3230, and a shell 3220.

The shell support 3210 is formed on an upper surface thereof with a second fitting holder 3410 and a second securing coupler 3420, and is formed on a lower surface thereof with a shell insertion hole 3211 into which an upper end of the shell 3220 is inserted.

The shell holding bar 3240 is disposed inside the shell support 3210 and reciprocates in a direction horizontal to the lower surface of the shell support 3210 so as to reciprocate in a region formed with the shell insertion hole 3211.

The second controller operates the second actuator 3230 in response to commands from the first controller and the second actuator 3230 moves the shell holding bar 3240 to reciprocate.

The shell 3220 is inserted into the shell insertion hole 3211 to be coupled to or uncoupled from the shell support 3210 by the shell holding bar 3240. Here, the shell 3220 is formed at an upper end thereof with a shell securing hole 3221.

That is, when the upper end of the shell 3220 is inserted into the shell insertion hole 3211 and the shell holding bar 3240 is horizontally moved towards the shell insertion hole 3211 by operation of the second actuator 3230, the shell holding bar 3240 passes through the shell securing hole 3221 to couple the shell 3220 to the shell support 3210.

In addition, when the second actuator 3230 is operated in response to a command to the second controller to allow the shell holding bar 3240 to move horizontally in an opposite direction to the shell insertion hole 3211, the shell holding bar 3240 inserted into the shell retaining hole 3211 is disengaged therefrom, whereby the shell 3220 can be disengaged from the shell support 3210 to be dropped to the ground.

Detailed description of the same components of the unmanned aerial vehicle according to the third embodiment as those of the unmanned aerial vehicle according to the first embodiment described above are omitted.

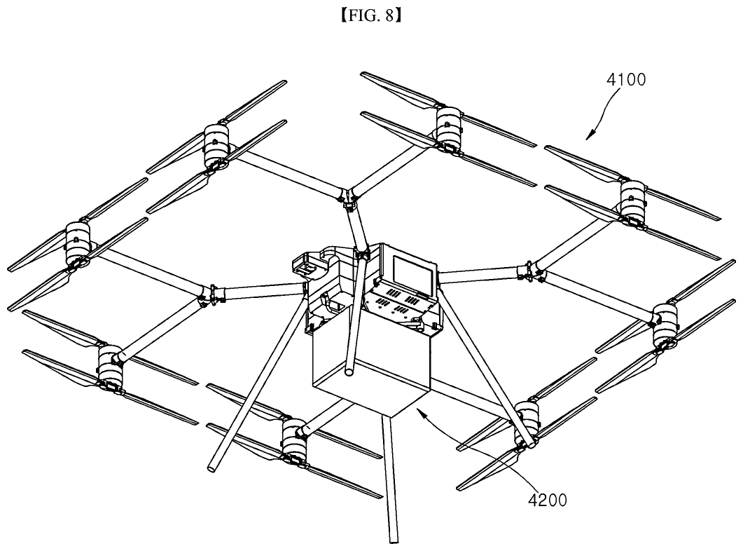

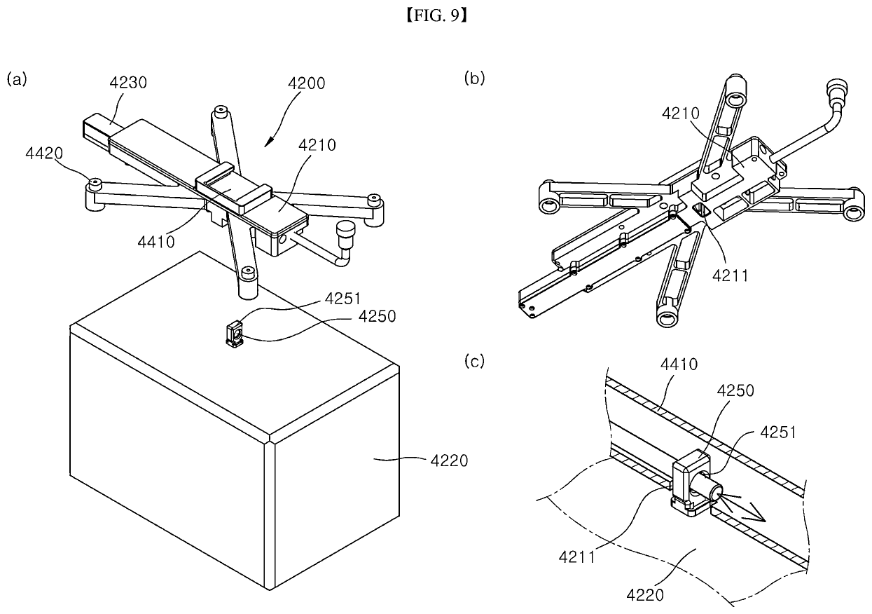

FIG. 8 is a schematic diagram of an unmanned aerial vehicle provided with a detachable transport mission apparatus according to a fourth embodiment of the present invention and FIG. 9 is a view of a transport mission apparatus and a second exchange unit 4400 of the unmanned aerial vehicle according to the fourth embodiment of the present invention.

Referring to FIG. 8 and FIG. 9, the unmanned aerial vehicle according to the fourth embodiment includes a main body 4100, a transport mission apparatus, a first exchange unit 4300, and a second exchange unit 4400. Here, details and description of each component of the unmanned aerial vehicle according to the third embodiment are the same as those of the unmanned aerial vehicle according to the first embodiment described above excluding some components.

According to the fourth embodiment, the transport mission apparatus of the unmanned aerial vehicle is a detachable cage transfer module 4200, which includes a detachable cage support 4210, a bracket holding bar 4240, a second controller, a third actuator 4230, a self-locking bracket 4250, and a cage 4220.

The detachable cage support 4210 is formed on an upper surface thereof with a second fitting holder 4410 and a second securing coupler 4420, and is formed on a lower surface thereof with a bracket insertion hole 4211 into which an upper end of the self-locking bracket 4250 is inserted.

The self-locking bracket 4250 is fixedly coupled to the upper surface of the cage 4220 to be coupled to or uncoupled from the detachable cage support 4210 by the bracket holding bar 4240. Here, the self-locking bracket 4250 is formed with a bracket holding bar-insertion hole 4251.

The bracket holding bar 4240 is disposed inside the detachable cage support 4210 and reciprocates in a direction horizontal to the lower surface of the detachable cage support 4210 so as to reciprocate in a region formed with the bracket insertion hole 4211.

The second controller operates the third actuator 4230 in response to commands from the first controller and the third actuator 4230 moves the bracket holding bar 4240 to reciprocate.

That is, when the self-locking bracket 4250 is inserted into the bracket insertion hole 4211 and the bracket holding bar 4240 is horizontally moved towards the bracket insertion hole 4211 by operation of the second actuator 3230, the bracket holding bar 4240 passes through the bracket holding bar-insertion hole 4251 to couple the self-locking bracket 4250 to the detachable cage support 4210, whereby the cage 4220 can be coupled to the detachable cage support 4210.

Further, when the third actuator 4230 is operated in response to a command to the second controller to allow the bracket holding bar 4240 to move horizontally in an opposite direction to the bracket insertion hole 4211, the bracket holding bar 4240 inserted into the bracket insertion hole 4251 is disengaged therefrom, whereby the cage 4220 can be disengaged from the detachable cage support 4210.

Detailed description of the same components of the unmanned aerial vehicle according to the third embodiment as those of the unmanned aerial vehicle according to the first embodiment described above are omitted.

Although some embodiments have been described herein with reference to the accompanying drawings, it should be understood that these embodiments are provided for illustration only and are not to be construed in any way as limiting the present invention, and that various modifications, changes, alterations, and equivalent embodiments can be made by those skilled in the art without departing from the spirit and scope of the invention and are not to be understood in individual form from the technical ideas or views of the invention.

### INDUSTRIAL APPLICABILITY

The present invention is applicable to an unmanned aerial vehicle provided with a detachable transport mission unit that allows various transportation items, such as cargo, shells, and the like, to be detachably coupled to and transported on a single unmanned aerial vehicle regardless of the type of drone.

1. An unmanned aerial vehicle provided with a detachable transport mission apparatus, the unmanned aerial vehicle comprising:
a main body;
a transport mission apparatus detachably coupled to the main body to transport a certain item;
a first exchange unit provided to a lower side of the main body to be coupled to or uncoupled from the transport mission apparatus; and
a second exchange unit provided to an upper side of the transport mission apparatus to be coupled to or uncoupled from the first exchange unit.

2. The device according to claim 1, wherein the first exchange unit comprises:
a first fitting holder protruding from a lower surface of the main body; and
a first securing coupler disposed on the lower surface of the main body and comprising at least one first securing hole.

3. The device according to claim 2, wherein the second exchange unit comprises:
a second fitting holder disposed on an upper surface of the transport mission apparatus and defining a fitting hole therein; and
a second securing coupler disposed on the upper surface of the transport mission apparatus and comprising at least one second securing hole.

4. The unmanned aerial vehicle according to claim 3, wherein the first fitting holder is inserted into the fitting hole formed in the second fitting holder, and the first securing hole and the second securing hole are disposed to face each other such that a center of the first securing hole and a center of the second securing hole are collinearly located.
